(19) United States
(12) Patent Application Publication
(10) Pub. No.: US 2023/0363570 A1
(43) Pub. Date: Nov. 16, 2023

(54) POUR-OVER COFFEE DRIPPER AND POUR-OVER DEVICE ASSEMBLY

(71) Applicant: GINO CREATION CO., LTD., Taipei City (TW)

(72) Inventor: KUANG-YU LIU, Taipei City (TW)

(21) Appl. No.: 18/129,942

(22) Filed: Apr. 3, 2023

(30) Foreign Application Priority Data
May 11, 2022 (TW) 111117584

(51) Int. Cl. A47J 31/06

(52) U.S. Cl. CPC A47J 31/0636

(57) ABSTRACT

A pour-over coffee dripper and a pour-over device assembly are provided. The pour-over coffee dripper includes a cup body, at least one center hole, a plurality of outer ring holes, and a plurality of outer ring hole columns. The center hole is formed on a center of the bottom wall or adjacent to the center of the bottom wall of the cup body. The outer ring holes and the outer ring hole columns are formed on the bottom wall of the cup body. Inner cavities of the plurality of outer ring hole columns are in spatial communication with the outer ring holes. The space in the cup body above an upper base line defined in the cup body is defined as an upper volume, and the space in the cup body below the upper base line is defined as a lower volume.

### CROSS REFERENCE TO RELATED PATENT APPLICATION

This application claims the benefit of priority to Taiwan Patent Application No. 111117584, filed on May 11, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a pour-over coffee dripper, and more particularly to a pour-over coffee dripper and a pour-over device assembly for brewing coffee.

### BACKGROUND OF THE DISCLOSURE

Coffee has become an everyday beverage, and pour-over coffee is greatly favored due to having a unique flavor. However, in the brewing of pour-over coffee, a certain level of skill is required to produce a cup of coffee that has a desirable flavor. For examples, factors such as the size of the hot water stream, the location where the hot water is poured, the path along which the hot water is poured, and the speed at which the hot water is poured can be difficult to manage and have become a barrier that is difficult for the general public to overcome. A water dispensing cup is a commercially available product that has two water pouring areas, namely an inner circle area and an outer circle area. The inner circle area and the outer circle area each has multiple water outlet holes formed therein. However, one disadvantage of using the water dispensing cup is that it is difficult to standardize the time to pour the hot water and the amount of the hot water being poured into the inner circle area and the outer circle area, so that the procedure for brewing a coffee beverage with good flavor cannot be easily duplicated.

### SUMMARY OF THE DISCLOSURE

In response to the above-referenced technical inadequacies, the present disclosure provides a pour-over coffee dripper and a pour-over device assembly that can be adapted to pour-over coffee using hot water, replace the need for a pour-over procedure that may be excessively professionalized or meticulous, and be capable of brewing a coffee beverage with good flavor.

In one aspect, the present disclosure provides a pour-over coffee dripper. The pour-over coffee dripper includes a cup body, at least one center hole, a plurality of outer ring holes, and a plurality of outer ring hole columns. The cup body has a side wall and a bottom wall. The side wall is annularly shaped, the bottom wall is connected to one end of the side wall, and another end of the side wall forms an opening. The at least one center hole is formed on a center of the bottom wall or adjacent to the center of the bottom wall. The center hole penetrates through the bottom wall. The plurality of outer ring holes are formed on the bottom wall and located on a periphery of the center hole. The plurality of outer ring holes penetrate through the bottom wall. The plurality of outer ring hole columns are formed on the bottom wall. The plurality of outer ring hole columns are hollow columns and are arranged upright on the bottom wall, and the plurality of outer ring hole columns correspond to the plurality of outer ring holes, respectively. The inner cavities of the plurality of outer ring hole columns are in spatial communication with the plurality of outer ring holes, respectively. An upper base line is defined in the cup body, and the upper base line is a horizontal line. The space in the cup body above the upper base line is defined as an upper volume, the space in the cup body below the upper base line is defined as a lower volume, a diameter of the upper volume is greater than a diameter of the lower volume, and a volume of the upper volume is greater than a volume of the lower volume. The plurality of outer ring hole columns are located in the lower volume, a lower base line is defined at upper ends of the plurality of outer ring hole columns, the lower base line is a horizontal line, and the lower base line is below the upper base line. After an amount of hot water is filled in the pour-over coffee dripper, the hot water is able to flow out from the center hole and the plurality of outer ring holes, respectively. When a water level in the pour-over coffee dripper is lowered to be lower than a height of the upper ends of the plurality of outer ring hole columns, the hot water stops flowing out from the plurality of outer ring holes, and all of the remaining hot water flows out from the center hole.

In another aspect, the present disclosure provides a pour-over device assembly. The pour-over device assembly includes a pour-over coffee dripper, a pour-over filter cup, and a container. The pour-over filter cup is able to be disposed below the pour-over coffee dripper, and the pour-over filter cup is able to be placed on the container.

Therefore, in the pour-over coffee dripper and the pour-over device assembly provided by the present disclosure, the pour-over coffee dripper includes a cup body, at least one center hole, a plurality of outer ring holes, and a plurality of outer ring hole columns. The at least one center hole is formed on a center of the bottom wall or adjacent to the center of the bottom wall of the cup body. The plurality of outer ring holes are formed on the bottom wall of the cup body and located on a periphery of the center hole. The plurality of outer ring hole columns are formed on the bottom wall of the cup body. The inner cavities of the plurality of outer ring hole columns are in spatial communication with the plurality of outer ring holes, respectively. An upper base line is defined in the cup body. The space in the cup body above the upper base line is defined as an upper volume, the space in the cup body below the upper base line is defined as a lower volume, a diameter of the upper volume is greater than a diameter of the lower volume, and a volume of the upper volume is greater than a volume of the lower volume. The plurality of outer ring hole columns are located in the lower volume, a lower base line is defined at upper ends of the plurality of outer ring hole columns, and the lower base line is below the upper base line. After an amount of hot water is filled in the pour-over coffee dripper, the hot water is able to flow out from the center hole and the plurality of outer ring holes, respectively. When a water level in the pour-over coffee dripper is lowered to be lower than a height of the upper ends of the plurality of outer ring hole columns, the hot water stops flowing out from the plurality of outer ring holes, and all of the remaining hot water flows out from the center hole. In the present disclosure, a hot water stream for brewing is focused at a center of coffee powder, and the hot water stream can allow a V-shaped concave to be formed in the coffee powder so that a wall of coffee powder is formed. The pour-over coffee dripper and the pour-over device assembly provided by the present disclosure can be adapted to pour-over coffee using hot water, and can replace the need for a pour-over procedure that may be excessively professionalized or meticulous, and be capable of brewing a coffee beverage with good flavor.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a pour-over coffee dripper according to a first embodiment of the present disclosure;

FIG. 2 is a schematic cross-sectional view of the pour-over coffee dripper according to the first embodiment of the present disclosure;

FIG. 3 is a schematic perspective view of the pour-over coffee dripper according to a second embodiment of the present disclosure in a use state;

FIG. 4 is a schematic perspective view of the pour-over coffee dripper according to a third embodiment of the present disclosure;

FIG. 5 is a schematic cross-sectional view of the pour-over coffee dripper according to the third embodiment of the present disclosure;

FIG. 6 is a schematic perspective view of the pour-over coffee dripper according to a fourth embodiment of the present disclosure;

FIG. 7 is a schematic cross-sectional view of the pour-over coffee dripper according to the fourth embodiment of the present disclosure;

FIG. 8 is a schematic perspective view of the pour-over coffee dripper according to a fifth embodiment of the present disclosure in a use state;

FIG. 9 is a schematic perspective view of the pour-over coffee dripper according to a sixth embodiment of the present disclosure in a use state;

FIG. 10 is a schematic perspective view of the pour-over coffee dripper according to a seventh embodiment of the present disclosure in a use state;

FIG. 11 is a schematic perspective view of the pour-over coffee dripper according to an eighth embodiment of the present disclosure in a use state;

FIG. 12 is a schematic perspective view of the pour-over coffee dripper according to a ninth embodiment of the present disclosure in a use state;

FIG. 13 is a schematic perspective view of the pour-over coffee dripper according to a tenth embodiment of the present disclosure;

FIG. 14 is a schematic cross-sectional view of the pour-over coffee dripper according to the tenth embodiment of the present disclosure; and

FIG. 15 is a schematic perspective view of the pour-over coffee dripper according to an eleventh embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

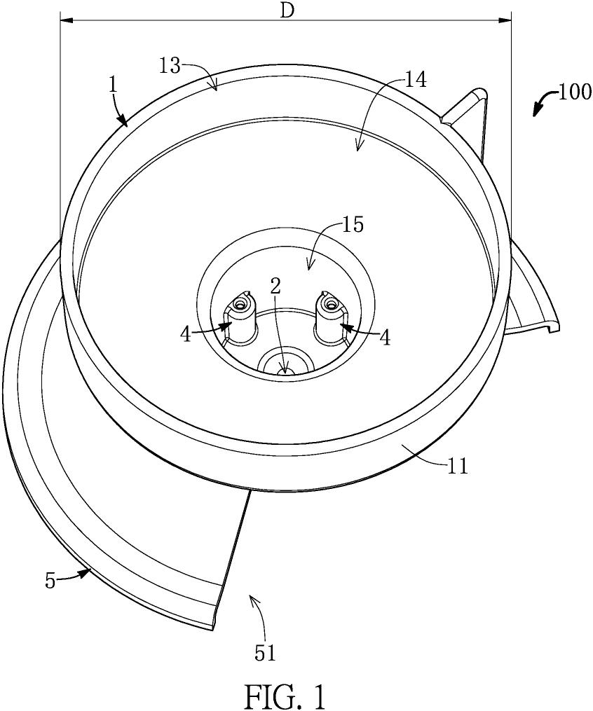

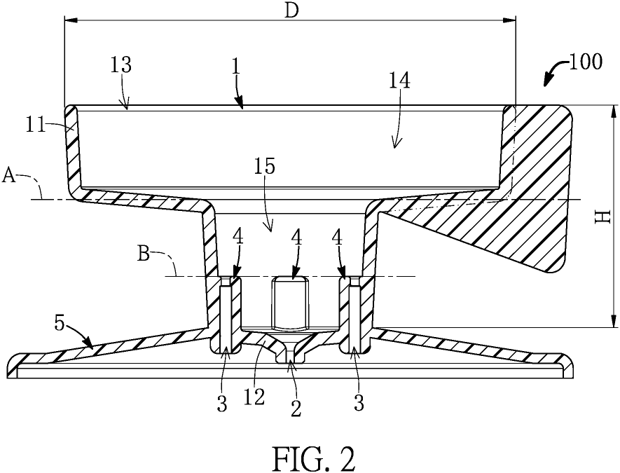

Referring to FIG. 1 and FIG. 2, a first embodiment of the present disclosure provides a pour-over coffee dripper 100 applicable to brewing pour-over coffee. The pour-over coffee dripper 100 includes a cup body 1, at least one center hole 2, and a plurality of outer ring holes 3. The cup body 1 has a hollow body, and the cup body 1 can be a round shaped cup body. However, a shape of the cup body 1 is not limited in the present disclosure. Preferably, a height H of the cup body 1 is not greater than an outer diameter D of the cup body 1. That is, the height H of the cup body 1 can be smaller than or equal to the outer diameter D of the cup body 1, but it is not limited thereto. The cup body 1 has a side wall 11 and a bottom wall 12. The side 11 wall is annularly shaped, and the side wall 11 can have an annular shape that has unequal diameters. Furthermore, the side wall 11 can be perpendicular to the bottom wall 12 or oblique (i.e., conical) to the bottom wall 12. In this embodiment, a diameter of an upper portion of the side wall 11 is greater than a diameter of a lower portion of the side wall 11. The bottom wall 12 is connected to one end (a lower end) of the side wall 11, and another end (an upper end) of the side wall 11 forms an opening 13.

The at least one center hole 2 is formed on a center of the bottom wall 12 or adjacent to the center of the bottom wall 12. The center hole 2 penetrates through the bottom wall 12. The plurality of outer ring holes 3 are formed on the bottom wall 12. The plurality of outer ring holes 3 are located on a periphery (an outer circle) of the center hole 2, and the plurality of outer ring holes 3 penetrate through the bottom wall 12. A number of the center hole 2 is one or more than one, and the number of the center hole 2 is preferably not more than four. As shown in FIG. 1, a single one of the center hole 2 is illustrated in FIG. 1, multiple outer ring holes 3 are formed surrounding the center hole 2, and the outer ring holes 3 can be arranged into a circle to surround the center hole 2.

A plurality of outer ring hole columns 4 are formed on the bottom wall 12. The plurality of outer ring hole columns 4 are hollow columns and are arranged upright on the bottom wall 12, and the plurality of outer ring hole columns 4 are spaced apart from each other. The plurality of outer ring hole columns 4 can also be connected to the side wall 11. The plurality of outer ring hole columns 4 correspond to the plurality of outer ring holes 3, respectively (as shown in FIG. 2). Inner cavities of the plurality of outer ring hole columns 4 are in spatial communication with the plurality of outer ring holes 3, respectively. A gap (a space) between two adjacent ones of the outer ring hole columns 4 can allow hot water distributed outside of the outer ring holes 3 to flow to the center hole 2, and a total flow amount of the hot water that flows out from the plurality of outer ring holes 3 in a unit time is greater than a beverage output flow amount (a coffee liquid flow amount) of a coffee filter for brewing in the unit time. After an amount of hot water is filled in the pour-over coffee dripper 100, the hot water is able to flow out from the center hole 2 and the plurality of outer ring holes 3, respectively. When a water level in the pour-over coffee dripper 100 is lowered to be lower than a height of upper ends of the plurality of outer ring hole columns 4, the hot water stops flowing out from the plurality of outer ring holes 3, and all of the remaining hot water flows out from the center hole 2.

In this embodiment, inner diameters of the upper ends of the plurality of outer ring hole columns 4 decrease such that the inner diameter of the upper end of each of the plurality of outer ring hole columns 4 is smaller than an inner diameter of a lower end of each of the plurality of outer ring hole columns 4. The plurality of outer ring hole columns 4 each has a certain height, the inner diameters of the upper ends of the plurality of outer ring hole columns 4 are designed to match with requirements of a brewing flow amount, and larger inner diameters at the lower ends of the plurality of outer ring hole columns 4 allow the hot water to flow more smoothly. The lower ends of the plurality of outer ring hole columns 4 can also protrude out from the bottom wall 12, so that the hot water flowing down from the pour-over coffee dripper 100 can be prevented from drifting.

The bottom wall 12 (a bottom of the cup body 1) can have an oblique surface, and a height of the bottom wall 12 decreases from an edge of the oblique surface toward the center hole 2, so that the hot water can flow to the center hole 2 and flow downward. A total flow amount of hot water that flow out from the plurality of outer ring holes 3 in a unit time is greater than a filter output flow amount of a coffee filter for pour-over brewing in the unit time, so that a brewer can increase a water flow to execute immersion and extraction procedures.

As shown in FIG. 2, an upper base line A is defined in the cup body 1, and the upper base line A is a horizontal line. The space in the cup body 1 above the upper base line A is defined as an upper volume 14, the space in the cup body 1 below the upper base line A is defined as a lower volume 15. Bottom portions of the upper volume 14 and the lower volume 15 respectively have oblique surfaces having heights that decrease from peripherals of the oblique surfaces toward centers of the oblique surfaces, so that water can be discharged from and do not remain in the cup body 1. The bottom portion of the lower volume 15 can have one to three water outlet holes formed thereon, and one center hole 2 is formed as shown in FIG. 1. The lower volume 15 can have the outer ring holes 3 formed thereon, and the number of the outer ring holes 3 can be three or more than three. The outer ring holes 3 can be arranged in a circle. A diameter of a circle formed by the outer ring holes 3 ranges from 18 mm to 30 mm, and preferably ranges from 24 mm to 28 mm.

The plurality of outer ring hole columns 4 are located in the lower volume 15, a lower base line B is defined at upper ends of the plurality of outer ring hole columns 4, and the lower base line B is a horizontal line. A volume of the space in the cup body 1 below the lower base line B preferably ranges from 6 cc (cubic centimeters) to 10 cc. The lower base line B is below the upper base line A, so that the lower base line B has a height difference with the upper base line A. A diameter of the upper volume 14 is greater than a diameter of the lower volume 15. That is, the upper volume 14 has a greater diameter, and the lower volume 15 has a smaller diameter. By such design, after the hot water is filled in for brewing coffee, due to the lower volume 15 having a smaller volume, a water level of the hot water can reach a level of a horizontal line, i.e., the upper base line A, faster, so that a water level difference is present between the water level of the hot water and entrances (the upper ends) of the outer ring hole columns 4, such that the hot water can smoothly flow out from the center hole 2 and the outer ring holes 3. By the design of the upper volume 14 having the greater diameter, when a larger amount of hot water is manually filled in, a height difference between the water level in the upper volume 14 and the upper base line A is not excessive. That is, from the beginning to the end of a water-filling process, because the upper volume 14 has a greater volume, a difference in the water level of the hot water is not excessive. Therefore, an output flow rate of the hot water is stable, and a process of brewing a pour-over coffee can be easily operated to achieve a consistent flavor of the coffee.

### Second Embodiment

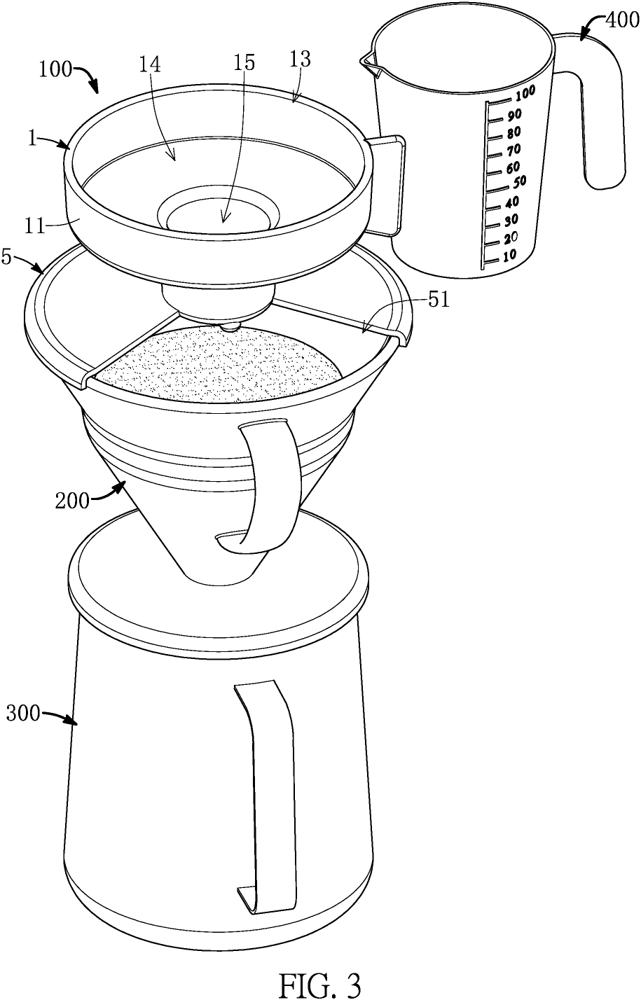

Referring to FIG. 3, in a second embodiment, the pour-over coffee dripper 100 further includes a base 5. The base 5 is connected to one end (a lower end) of the cup body 1. The base 5 can be placed on a pour-over filter cup 200, so that the pour-over filter cup 200 is disposed below the pour-over coffee dripper 100, and the pour-over filter cup 200 is further placed on a container 300. The base 5 can have a viewing window 51 formed thereon, so that when a brewing process is executed, a brewing status of coffee power can be observed by a user through the viewing window 51, and the user can be informed of statuses of gas discharge and brewing progress of the coffee powder. If the pour-over coffee dripper 100 is made of materials such as food-grade transparent plastic or glass, the viewing window 51 of the base 5 can be omitted.

Referring to FIG. 1 to FIG. 3, the center hole 2 and the outer ring holes 3 are designed so that in a brewing process, an impact of the flow of the hot water stream can form a V-shaped concave in the center of the coffee powder of the pour-over filter cup 200. A wall of the coffee powder of the V-shaped concave allows the hot water to more uniformly infiltrate into the coffee powder, so that an effect of extracting the coffee powder can be improved. The center hole 2 is further designed so that when a small amount of hot water is filled in the pour-over coffee dripper 100, the hot water can flow out only from the center hole 2, so that the hot water flows out from the center hole 2 to the center of the top of the coffer powder and performs immersion (also called a blooming process) for a certain period of time, and the hot water then downwardly wets the coffee powder from the center of the top of the coffer powder. Afterwards, more hot water is filled in the pour-over coffee dripper 100 so that the hot water flows out from the center hole 2 and the outer ring holes 3. A total water output flow amount of the pour-over coffee dripper 100 in a unit time is designed to be greater than an output flow amount of coffee beverage during coffee brewing in the unit time; therefore, when the hot water flows out from both the center hole 2 and the outer ring holes 3, the hot water in the pour-over filter cup 200 covers all of the coffee powder, so that the coffee powder is more uniformly wetted after the blooming process is executed. Each time the water level of the hot water is lowered to the lower base line B, the hot water only flows out from the center hole 2, and such process imitates a professional pour-over brewer pouring the hot water back to a center of the top of the coffee powder at the end of a water pouring process. Considering a measuring cup 400 and a pour-over coffee brewing process, a total volume of the pour-over coffee dripper 100 can be 120 cc, and a maximum water pouring amount of the measuring cup 400 is 100 cc. Such design can satisfy requirements of a conventional pour-over coffee brewing process. If a pour-over coffee dripper 100 having a large volume does not interfere with a brewing function, the pour-over coffee dripper 100 can be designed to have a large volume, and it is not limited thereto.

An operation process of this embodiment is described as follows. First, an adequate amount of hot water is taken from a hot water bottle using the measuring cup 400. In one implementation, 20 g of coffee powder is brewed using 300 cc of hot water in four phases. In a first phase, 40 cc of hot water is added to the coffee powder so that the blooming process is performed for 30 seconds. In each of a second phase and a third phase, 80 cc of hot water is added to the coffee powder and then the coffee powder is left to stand for 30 seconds. In a fourth phase, 80 cc of hot water is added to the coffee powder. After all of the coffee liquid flows out from the pour-over filter cup 200, the brewing process is completed. In a practical implementation, the measuring cup 400 is used to take 40 cc of hot water to fill in the pour-over coffee dripper 100. A stopwatch or a stopwatch function of a mobile phone can be used to count 30 seconds for performing the blooming process. Afterwards, the measuring cup 400 is used for pouring 80 cc of hot water in the pour-over coffee dripper 100. After 30 seconds, the measuring cup 400 is again used for pouring 80 cc of hot water in the pour-over coffee dripper 100. After another 30 seconds, 100 cc of hot water is poured in the pour-over coffee dripper 100. Then, after all of the coffee liquid flows out from the pour-over filter cup 200, the brewing process for the pour-over coffee is completed. In other implementations, the measuring cup 400 can be replaced by a hot water kettle dedicated for pour-over coffee, and an electronic scale can be used for measuring and time counting. The pour-over coffee dripper 100 can be better used in conjunction with specialized devices, but these devices are common and are only briefly described herein without being illustrated in the figures.

### Third Embodiment

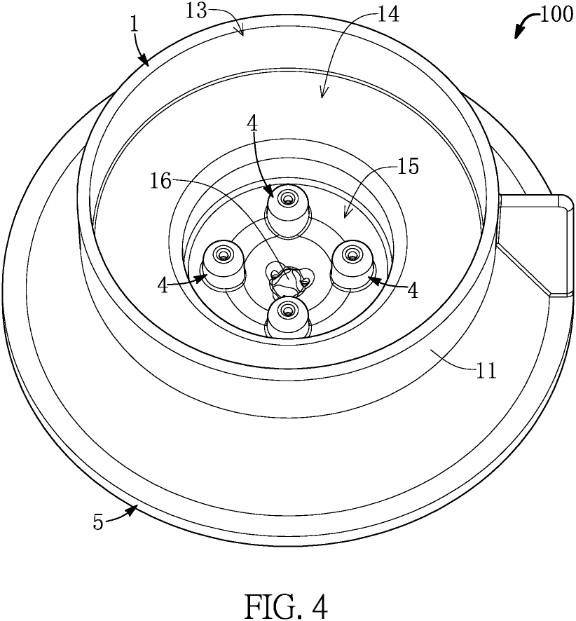

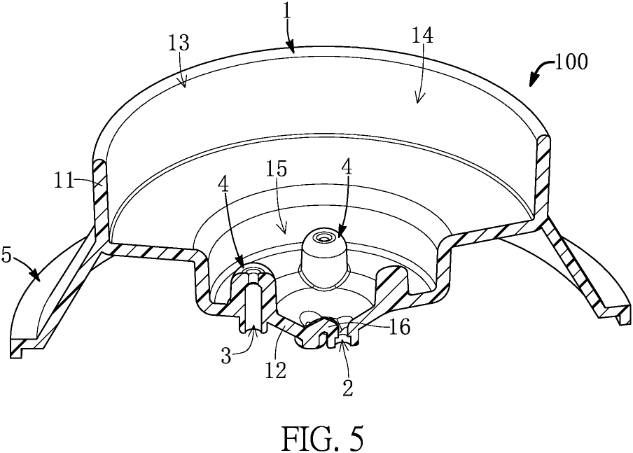

Referring to FIG. 4 and FIG. 5, in a third embodiment, a number of the outer ring holes 3 is four. The outer ring hole columns 4 are each spaced apart from the side wall 11 by a gap. A circle formed by a circular arrangement of the outer ring holes 3 preferably has a diameter that ranges from 24 mm to 28 mm. Bottom portions of the upper volume 14 and the lower volume 15 have oblique surfaces having heights that decrease from peripherals of the oblique surfaces toward centers of the oblique surfaces to facilitate water discharging. A number of the center hole 2 is three, and the three center holes 2 surround the center of the bottom wall 12. The center of the bottom wall 12 protrudes upward to form a protrusion 16 to facilitate water discharging, so that water does not remain in the cup body 1. In this embodiment, the base 5 of the pour-over coffee dripper 100 is circular-shaped without a viewing window.

### Fourth Embodiment

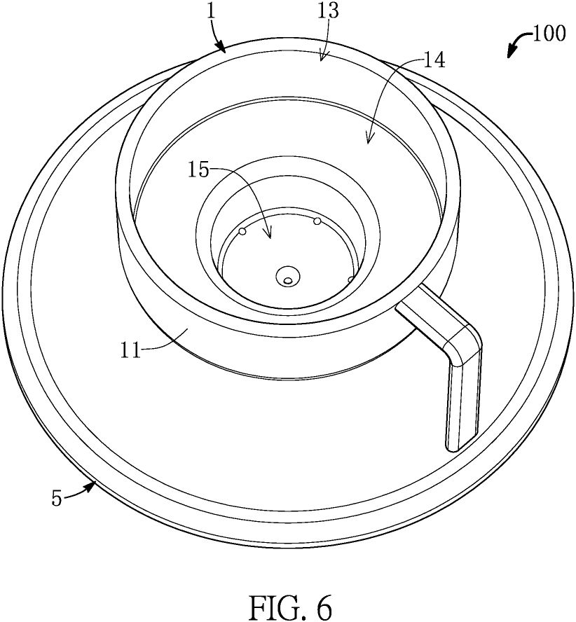

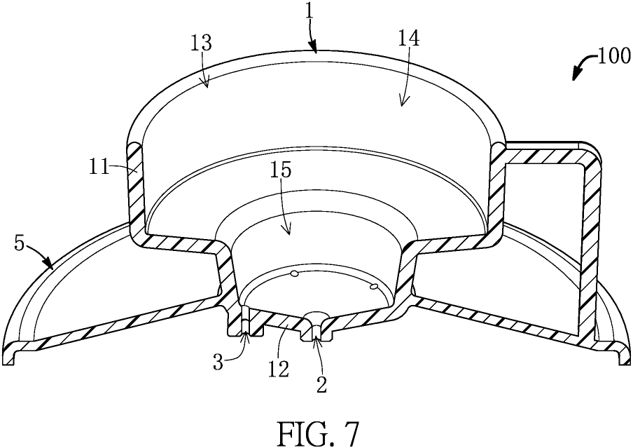

Referring to FIG. 6 and FIG. 7, in a fourth embodiment, combinations and arrangements of the center hole 2 and the outer ring holes 3 are the same as aforementioned embodiments, and a difference in this embodiment is that the outer ring hole columns 4 are omitted in this embodiment, so that this embodiment does not have a central water outflow function. The upper volume 14 and the lower volume 15 are designed so that when the hot water is filled in the pour-over coffee dripper 100, due to the lower volume 15 having a smaller volume, a water level can easily rise higher than the lower volume 15. The water level of the hot water in the pour-over coffee dripper 100 is higher, thereby causing the hot water to easily flow out from water outlet holes. The upper volume 14 has a larger volume, so that when a larger amount of hot water is filled in the pour-over coffee dripper 100, a water lever difference is not excessive and a flow rate of the hot water is stable. At the end of each process of a water outflow of the hot water flowing out from the pour-over coffee dripper 100, due to the lower volume 15 having a small volume, the water flow at the end of the process of water outflow from the pour-over coffee dripper 100 is smooth. If the pour-over coffee dripper 100 is designed to have only one continuous volume without being divided into the upper volume 14 and the lower volume 15, when the pour-over coffee dripper 100 contains less amount of the hot water, a flow rate of the hot water becomes slower and some of the hot water can easily remain in the pour-over coffee dripper 100.

### Fifth Embodiment

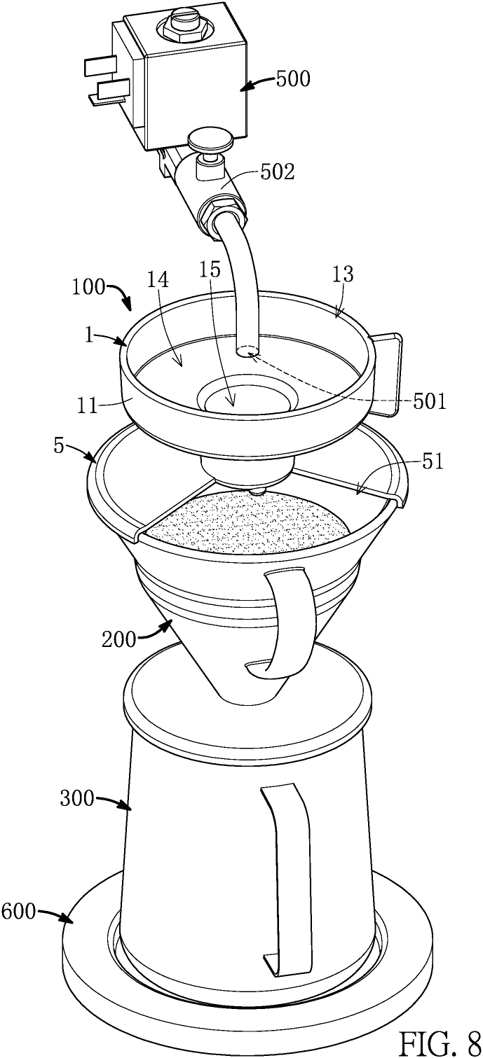

Referring to FIG. 8, in a fifth embodiment, the pour-over coffee dripper 100 of the present disclosure is adapted to a commercial brewing mechanism or an automatic brewing mechanism. The measuring cup 400 as shown in FIG. 3 is replaced by a hot water outflow device. As shown in FIG. 8, the hot water outflow device is a hot water electromagnetic valve 500, and a throttle valve 502 adjusts an amount of hot water, e.g., in cc per second, that flows out. The throttle valve 502 can be replaced by a throttle connector, and according to the pour-over coffee brewing process, an automatic control system controls duration and interval of switching-on and switching-off of the hot water electromagnetic valve 500 to execute the pour-over coffee brewing process. The container 300 can be placed on a positioning seat 600 that positions the pour-over coffee dripper 100 to be co-centered with a hot water outlet hole 501 of the hot water electromagnetic valve 500, so that the hot water can be transported (filled) to a center of the pour-over coffee dripper 100. An automatic water outlet device is not limited to the hot water electromagnetic valve 500, and a hot water supply system is a conventional hot water mechanism that is not shown in the figures. The upper volume 14 of the pour-over coffee dripper 100 has a larger diameter. By such design, when a larger amount of hot water is filled in the pour-over coffee dripper 100, due to the upper volume 14 having a larger volume, a water lever difference is not excessive in the pour-over coffee dripper 100 and a flow rate of the hot water that flows out from the pour-over coffee dripper 100 is stable, so that a taste of the coffee that is brewed is easily controlled.

### Sixth Embodiment

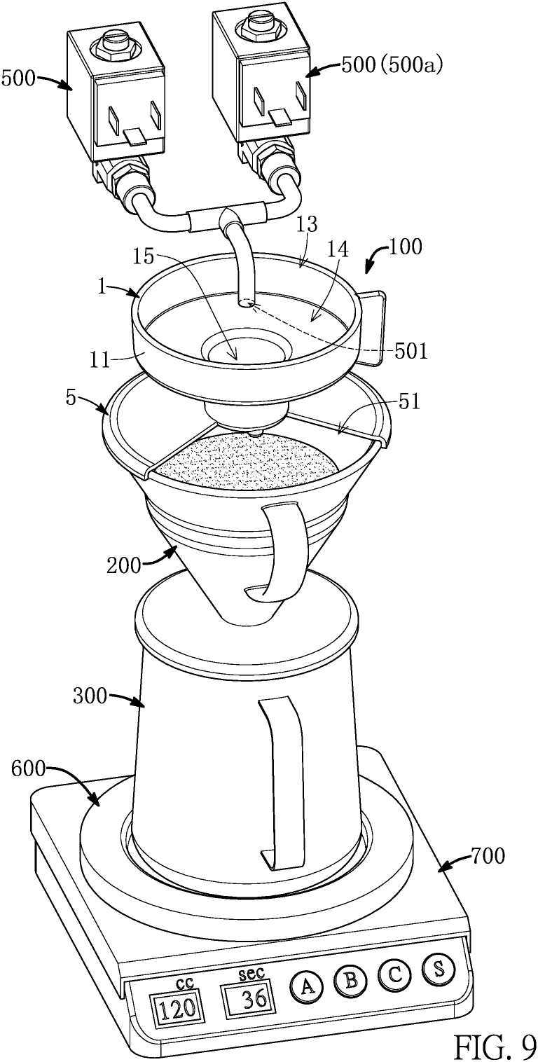

Referring to FIG. 9, in a sixth embodiment, the positioning seat 600 is mounted on an electronic scale 700 for positioning the container 300. Therefore, the container 300, the pour-over filter cup 200, and the pour-over coffee dripper 100 can be positioned for brewing. The positioning seat 600 has large and small brewing seats for placing different containers 300 corresponding to a single cup amount or a double cup amount of coffee. A hot water supply end of the hot water electromagnetic valve 500 is a hot water supply device that is a conventional mechanism and is not shown in the figures. This embodiment includes two hot water electromagnetic valves 500, and the two hot water electromagnetic valves 500 have three modes of implementation. In a first mode of implementation, each of the two hot water electromagnetic valves 500 has a same flow amount. When brewing a single cup amount of coffee, one of the two hot water electromagnetic valves 500 is switched on and switched off, and when brewing a double cup amount of coffee, both of the two hot water electromagnetic valves 500 are switched on and switched off. The switching-on and switching-off of the hot water electromagnetic valves 500 is configured according to the pour-over coffee brewing process.

In a second mode of implementation, a hot water electromagnetic valve 500 and a room-temperature water electromagnetic valve 500a are provided, and a frequency of switching-on and switching-off the hot water electromagnetic valve 500 and the room-temperature water electromagnetic valve 500a is used to control a temperature of the water that is output. The automatic control system respectively configures a brewing process for each operation button according to operation processes of pour-over coffee. The container 300 is placed on the positioning seat 600 of the electronic scale 700. After a coffee filter is placed in the pour-over filter cup 200, a predetermined amount of coffee powder is placed in the pour-over filter cup 200, and the pour-over filter cup 200 is placed on the container 300. Finally, the pour-over coffee dripper 100 is placed on the pour-over filter cup 200, and one of the operation buttons, such as a button having the letter A, is pressed. Then, the automatic control system automatically deducts a current weight in order to reset the electronic scale 700 back to zero, and executes a preset pour-over coffee brewing process.

In a third mode of implementation, the two hot water electromagnetic valves 500 have a same or different flow amounts. When brewing, one of the two hot water electromagnetic valves 500 is switched on and switched off so that a low water level brewing is performed in the pour-over filter cup 200. When more hot water is needed to cover the coffee powder in the pour-over filter cup 200, another one of the two hot water electromagnetic valves 500 can be switched on and switched off for controlling a high water level brewing.

### Seventh Embodiment

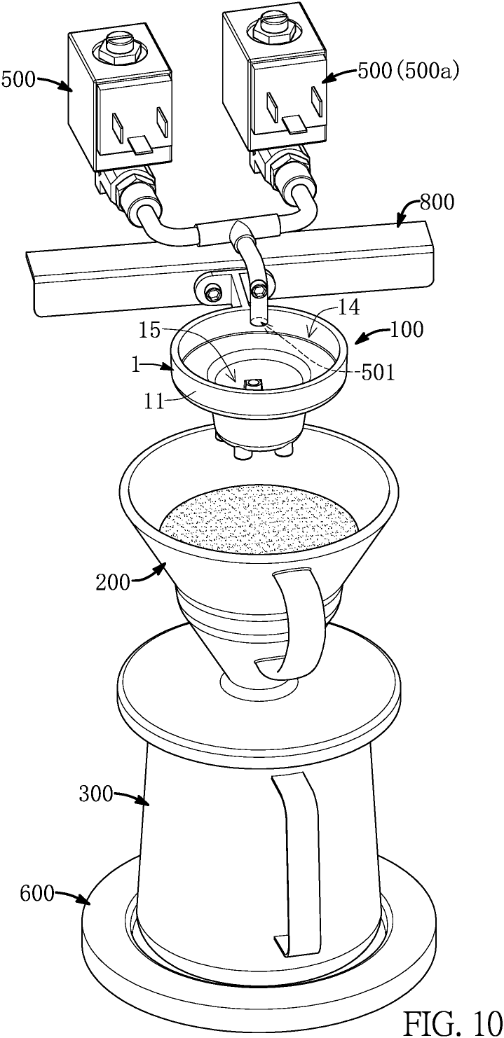

Referring to FIG. 10, in a seventh embodiment, the pour-over coffee dripper 100 is fixed to a pour-over mechanism 800 (briefly illustrated in the figure), and functions of the two electromagnetic valves are the same as abovementioned embodiments. The automatic control system is used to control the frequency of switching-on and switching-off the hot water electromagnetic valve 500 and the room-temperature water electromagnetic valve 500a according to the pour-over coffee brewing process and a coffee brewing temperature setting, so that the pour-over coffee brewing process is executed.

### Eighth Embodiment

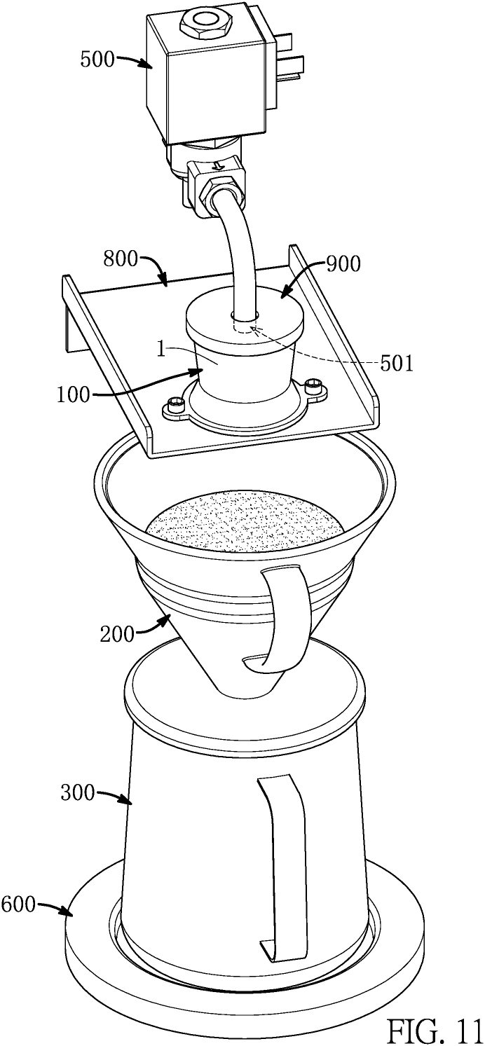

Referring to FIG. 11, in an eighth embodiment, the pour-over coffee dripper 100 of the present disclosure is adapted to a commercial brewing system or an automatic brewing system. Because an automatic control device is used for controlling the supply of the hot water for brewing, a water input amount of the hot water can be designed to be marginally greater than a water outflow amount of the pour-over coffee dripper 100. The higher the water level of the hot water in the pour-over coffee dripper 100 is, the faster the flow rate of the hot water flowing out of the pour-over coffee dripper 100 is. At a predetermined water level, the water input amount is equal to the water outflow amount. That is, when a water level of the hot water in the pour-over coffee dripper 100 reaches the predetermined water level that is an adequate water level, the water level stops increasing, such that the pour-over coffee dripper 100 does not need to be designed to have the upper volume 14 for containing more amount of the hot water. An upper cover 900 can be provided for the pour-over coffee dripper 100. The upper cover 900 covers on the opening 13 of the cup body 1 to decrease an evaporation rate of the hot water and to prevent cockroaches from crawling into the pour-over coffee dripper 100 when the pour-over coffee dripper 100 is not in use. The upper cover 900 can be threadedly fixed on the pour-over coffee dripper 100 by using screws, the upper cover 900 can also be configured to be combined with the pour-over coffee dripper 100 by ways of screw-cap, and the present disclosure is not limited thereto. In the figure, the pour-over coffee dripper 100 is fixed on the pour-over mechanism 800.

### Ninth Embodiment

The coffee beverages offered by coffee and beverage stores are becoming more diversified, such as espresso coffee, pour-over coffee, and Americano coffee. If a pour-over coffee device and an espresso coffee device are connected, then one machine can brew both the espresso coffee and the pour-over coffee, such that both the espresso coffee and the pour-over coffee can be provided. This not only saves the cost of purchasing multiple machines, but also saves spaces of the bar. Furthermore, the pour-over coffee having a consistent taste can be repeatedly provided without the need of skilled professionals.

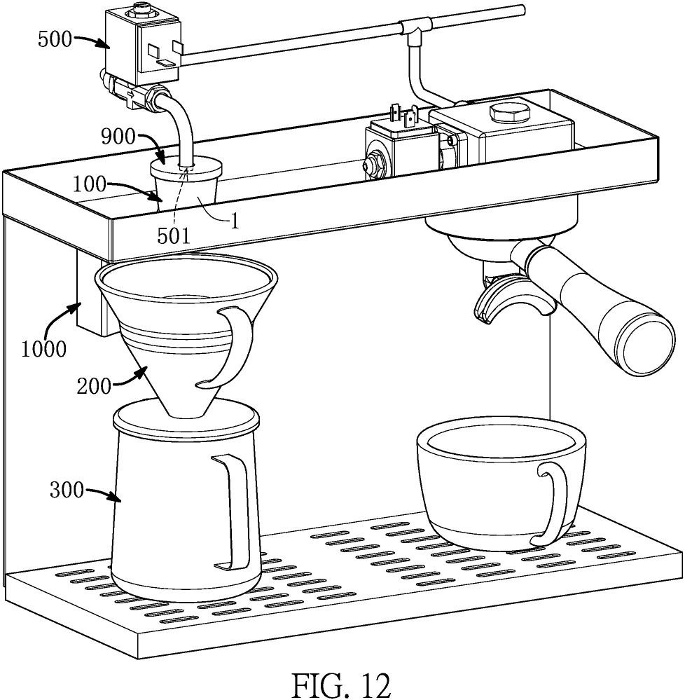

Referring to FIG. 12, in a ninth embodiment, hot water tubes at water outlet ends of a hot water supply device for brewing are respectively connected to an espresso coffee brewing device and a pour-over coffee brewing device, so that a dual-use device is assembled. The pour-over coffee brewing device is the pour-over coffee dripper 100, and an espresso coffee brewing process and the pour-over coffee brewing process are automatically executed by the automatic control system according to the brewing processes, respectively. When an espresso coffee operation button is pressed, the espresso coffee brewing process is executed, and when a pour-over coffee operation button is pressed, the pour-over coffee brewing process is executed by using the same hot water supply device and automatic control system, such that a same device can be used in two manners. When the pour-over coffee is brewed, the automatic control system switches on and switches off a pump and the hot water electromagnetic valve 500 according to a preset process, and a flow meter is used to measure the water flow. A pressure of the hot water output by the pump ranges from 8 bar to 10 bar. When the hot water flows to the pour-over coffee dripper 100, air is permeable between the pour-over coffee dripper 100 and the upper cover 900, so that the hot water in the pour-over coffee dripper 100 flows down to the pour-over filter cup 200 for brewing a pour-over coffee at a pressure that is approximately 1 atm.

When placing the pour-over filter cup 200, an upper edge of the pour-over filter cup 200 lightly contacts with a positioning rack 1000, so that the pour-over filter cup 200 and the pour-over coffee dripper 100 are positioned to be co-centered for properly executing the pour-over coffee brewing process. A height of the positioning rack 1000 can be adjusted to be higher or lower, so that the pour-over filter cup 200 can be positioned to the same position when containers 300 having different heights are used. A positioning rack 1000 can be replaced by a container seat or various equivalent devices.

### Tenth Embodiment

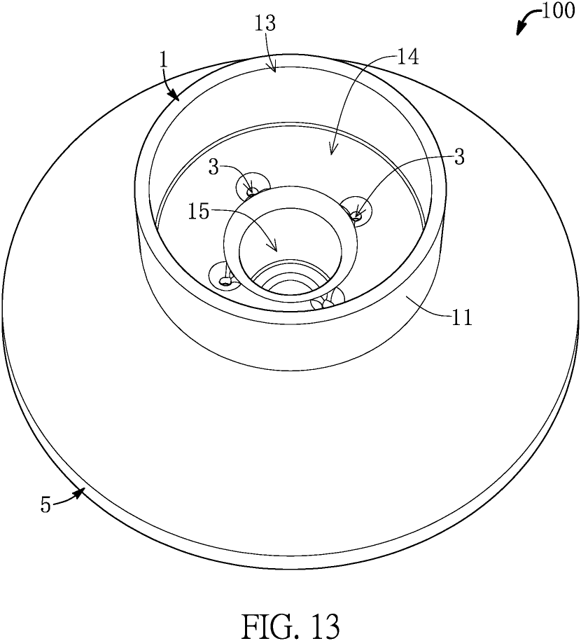

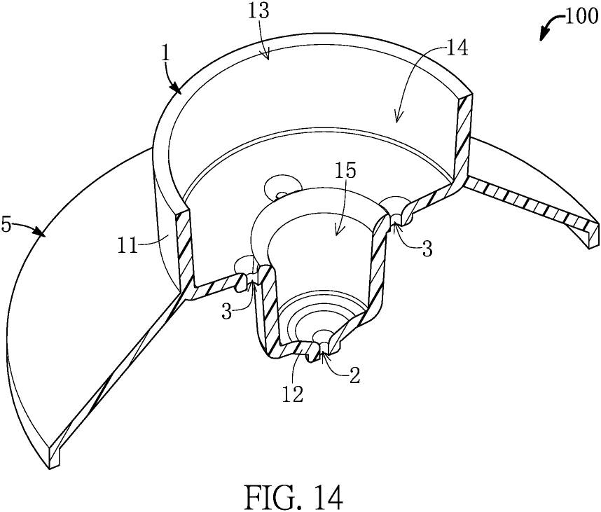

Referring to FIG. 13 and FIG. 14, in a tenth embodiment, a main difference is that the outer ring hole columns 4 are omitted, the center hole 2 is formed at the bottom portion of the lower volume 15, and the center hole 2 penetrates through the bottom portion of the lower volume 15. Furthermore, the outer ring holes 3 are formed at the bottom portion of the upper volume 14, the outer ring holes 3 penetrate through the bottom portion of the upper volume 14, and the outer ring holes 3 are located at the periphery of the center hole 2. After an amount of the hot water is filled in the pour-over coffee dripper 100, the hot water is able to flow out from the center hole 2 and the plurality of outer ring holes 3, respectively. When a water level in the pour-over coffee dripper 100 is lowered to be lower than a height of upper ends of the plurality of outer ring holes 3, the hot water stops flowing out from the plurality of outer ring holes 3, and all of the remaining hot water flows out from the center hole 2.

### Eleventh Embodiment

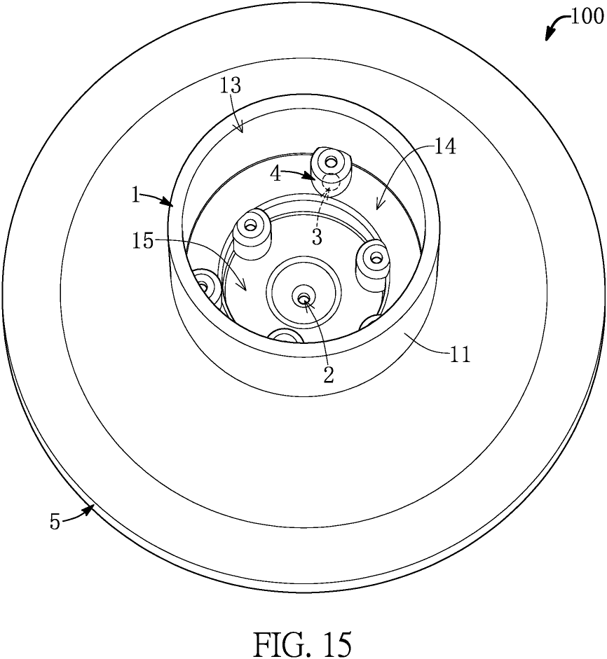

Referring to FIG. 15, in an eleventh embodiment, a main difference is that the outer ring hole columns 4 and the outer ring holes 3 are arranged into multiple circles for brewing beverage for a pour-over cup that has a larger volume.

### Beneficial Effects of the Embodiments

In conclusion, in the pour-over coffee dripper and the pour-over device assembly provided by the present disclosure, the pour-over coffee dripper includes a cup body, at least one center hole, a plurality of outer ring holes, and a plurality of outer ring hole columns. The at least one center hole is formed on a center of the bottom wall or adjacent to the center of the bottom wall of the cup body. The plurality of outer ring holes are formed on the bottom wall of the cup body and located on a periphery of the center hole. The plurality of outer ring hole columns are formed on the bottom wall of the cup body. The inner cavities of the plurality of outer ring hole columns are in spatial communication with the plurality of outer ring holes, respectively. An upper base line is defined in the cup body. The space in the cup body above the upper base line is defined as an upper volume, the space in the cup body below the upper base line is defined as a lower volume, a diameter of the upper volume is greater than a diameter of the lower volume, and a volume of the upper volume is greater than a volume of the lower volume. The plurality of outer ring hole columns are located in the lower volume, a lower base line is defined at upper ends of the plurality of outer ring hole columns, and the lower base line is below the upper base line. After an amount of hot water is filled in the pour-over coffee dripper, the hot water is able to flow out from the center hole and the plurality of outer ring holes, respectively. When a water level in the pour-over coffee dripper is lowered to be lower than a height of the upper ends of the plurality of outer ring hole columns, the hot water stops flowing out from the plurality of outer ring holes, and all of the remaining hot water flows out from the center hole. In the present disclosure, a hot water stream for brewing is focused at a center of coffee powder, and the hot water stream can allow a V-shaped concave to be formed in the coffee powder so that a wall of coffee powder is formed. The pour-over coffee dripper and the pour-over device assembly provided by the present disclosure can be adapted to pour-over coffee using hot water, and can replace the need for a pour-over procedure that may be excessively professionalized or meticulous, and be capable of brewing a coffee beverage with good flavor.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pour-over coffee dripper, comprising:
a cup body having a side wall and a bottom wall, wherein the side wall is annularly shaped, the bottom wall is connected to one end of the side wall, and another end of the side wall forms an opening;
at least one center hole being formed on a center of the bottom wall or adjacent to the center of the bottom wall, wherein the center hole penetrates through the bottom wall;
a plurality of outer ring holes being formed on the bottom wall and located on a periphery of the center hole, wherein the plurality of outer ring holes penetrate through the bottom wall; and
a plurality of outer ring hole columns being formed on the bottom wall, wherein the plurality of outer ring hole columns are hollow columns and are arranged upright on the bottom wall, and the plurality of outer ring hole columns correspond to the plurality of outer ring holes, respectively, and wherein inner cavities of the plurality of outer ring hole columns are in spatial communication with the plurality of outer ring holes, respectively;
wherein an upper base line is defined in the cup body, and the upper base line is a horizontal line; wherein the space in the cup body above the upper base line is defined as an upper volume, the space in the cup body below the upper base line is defined as a lower volume, a diameter of the upper volume is greater than a diameter of the lower volume, and a volume of the upper volume is greater than a volume of the lower volume; wherein the plurality of outer ring hole columns are located in the lower volume, a lower base line is defined at upper ends of the plurality of outer ring hole columns, the lower base line is a horizontal line, and the lower base line is below the upper base line; wherein, after an amount of hot water is filled in the pour-over coffee dripper, the hot water is able to flow out from the center hole and the plurality of outer ring holes, respectively; wherein, when a water level in the pour-over coffee dripper is lowered to be lower than a height of the upper ends of the plurality of outer ring hole columns, the hot water stops flowing out from the plurality of outer ring holes, and all of the remaining hot water flows out from the center hole.

2. The pour-over coffee dripper according to claim 1, wherein the outer ring holes surround the center hole, the outer ring holes are arranged in a circle, and a diameter of the circle formed by the arrangement of the outer ring circle is from 18 mm to 30 mm.

3. The pour-over coffee dripper according to claim 1, wherein inner diameters of the upper ends of the plurality of outer ring hole columns decrease such that the inner diameter of the upper end of each of the plurality of outer ring hole columns is smaller than an inner diameter of a lower end of each of the plurality of outer ring hole columns, and the lower ends of the plurality of outer ring hole columns protrude from the bottom wall.

4. The pour-over coffee dripper according to claim 1, wherein the bottom wall has an oblique surface, and a height of the bottom wall decreases from an edge of the oblique surface toward the center hole.

5. The pour-over coffee dripper according to claim 1, wherein bottom portions of the upper volume and the lower volume have oblique surfaces having heights that decrease from peripherals of the oblique surfaces toward centers of the oblique surfaces.

6. The pour-over coffee dripper according to claim 1, wherein a volume in the cup body below the lower base line ranges from 6 cc (cubic centimeters) to 10 cc.

7. A pour-over device assembly, comprising:
a pour-over coffee dripper including:
a cup body having a side wall and a bottom wall, wherein the side wall is annularly shaped, the bottom wall is connected to one end of the side wall, and another end of the side wall forms an opening;
at least one center hole being formed on a center of the bottom wall or adjacent to the center of the bottom wall, wherein the center hole penetrates through the bottom wall;
a plurality of outer ring holes being formed on the bottom wall and located on a periphery of the center hole, wherein the plurality of outer ring holes penetrate through the bottom wall; and
a plurality of outer ring hole columns being formed on the bottom wall, wherein the plurality of outer ring hole columns are hollow columns and are arranged upright on the bottom wall, and the plurality of outer ring hole columns correspond to the plurality of outer ring holes, respectively, and wherein inner cavities of the plurality of outer ring hole columns are in spatial communication with the plurality of outer ring holes, respectively;
wherein an upper base line is defined in the cup body, and the upper base line is a horizontal line; wherein the space in the cup body above the upper base line is defined as an upper volume, the space in the cup body below the upper base line is defined as a lower volume, a diameter of the upper volume is greater than a diameter of the lower volume, and a volume of the upper volume is greater than a volume of the lower volume; wherein the plurality of outer ring hole columns are located in the lower volume, a lower base line is defined at upper ends of the plurality of outer ring hole columns, the lower base line is a horizontal line, and the lower base line is below the upper base line; wherein, after an amount of hot water is filled in the pour-over coffee dripper, the hot water is able to flow out from the center hole and the plurality of outer ring holes, respectively; wherein, when a water level in the pour-over coffee dripper is lowered to be lower than a height of the upper ends of the plurality of outer ring hole columns, the hot water stops flowing out from the plurality of outer ring holes, and all of the remaining hot water flows out from the center hole;
a pour-over filter cup able to be disposed below the pour-over coffee dripper; and
a container, wherein the pour-over filter cup is able to be placed on the container.

8. The pour-over device assembly according to claim 7, further comprising at least one hot water electromagnetic valve for transporting hot water to the pour-over coffee dripper.

9. The pour-over device assembly according to claim 8, wherein the container is placed on a positioning seat that positions the pour-over coffee dripper to be co-centered with a hot water outlet hole of the hot water electromagnetic valve, so that the hot water can be transported to a center of the pour-over coffee dripper.

10. The pour-over device assembly according to claim 7, further comprising an electronic scale, wherein a positioning seat is mounted on the electronic scale for positioning the container.

11. The pour-over device assembly according to claim 7, wherein the outer ring holes surround the center hole, the outer ring holes are arranged in a circle, and a diameter of the circle formed by the arrangement of the outer ring circle is from 18 mm to 30 mm.

12. The pour-over device assembly according to claim 7, wherein inner diameters of the upper ends of the plurality of outer ring hole columns decrease such that the inner diameter of the upper end of each of the plurality of outer ring hole columns is smaller than an inner diameter of a lower end of each of the plurality of outer ring hole columns, and the lower ends of the plurality of outer ring hole columns protrude from the bottom wall.

13. The pour-over device assembly according to claim 7, wherein the bottom wall has an oblique surface, and a height of the bottom wall decreases from an edge of the oblique surface toward the center hole.

14. The pour-over device assembly according to claim 7, wherein bottom portions of the upper volume and the lower volume have oblique surfaces having heights that decrease from peripherals of the oblique surfaces toward centers of the oblique surfaces.

15. The pour-over device assembly according to claim 7, wherein a volume in the cup body below the lower base line ranges from 6 cc (cubic centimeters) to 10 cc.

16. The pour-over device assembly according to claim 7, being configured to be combined with an espresso coffee brewing device to form a dual-use device.

17. A pour-over coffee dripper, comprising:
a cup body having a side wall and a bottom wall, wherein the side wall is annularly shaped, the bottom wall is connected to one end of the side wall, and another end of the side wall forms an opening;
at least one center hole; and
a plurality of outer ring holes;
wherein an upper base line is defined in the cup body, and the upper base line is a horizontal line; wherein the space in the cup body above the upper base line is defined as an upper volume, the space in the cup body below the upper base line is defined as a lower volume, a diameter of the upper volume is greater than a diameter of the lower volume, and a volume of the upper volume is greater than a volume of the lower volume; wherein the at least one center hole is formed on the bottom wall, and the center hole penetrates through the bottom wall; wherein the plurality of outer ring holes are formed on the bottom wall and penetrate through the bottom wall, and the plurality of outer ring holes are located on a periphery of the at least one center hole; wherein, after an amount of hot water is filled in the pour-over coffee dripper, the hot water is able to flow out from the at least one center hole and the plurality of outer ring holes, respectively; wherein, when a water level in the pour-over coffee dripper is lowered to be lower than a height of upper ends of the plurality of outer ring holes, the hot water stops flowing out from the plurality of outer ring holes, and all of the remaining hot water flows out from the center hole.

18. A pour-over coffee dripper, comprising:
a cup body having a side wall and a bottom wall, wherein the side wall is annularly shaped, the bottom wall is connected to one end of the side wall, and another end of the side wall forms an opening;
at least one center hole being formed on a center of the bottom wall or adjacent to the center of the bottom wall, wherein the at least one center hole penetrates through the bottom wall;
a plurality of outer ring holes being formed on the bottom wall and located on a periphery of the at least one center hole, wherein the plurality of outer ring holes penetrate through the bottom wall; and
a plurality of outer ring hole columns being formed on the bottom wall, wherein the plurality of outer ring hole columns are hollow columns and are arranged upright on the bottom wall, and the plurality of outer ring hole columns correspond to the plurality of outer ring holes, respectively, and wherein inner cavities of the plurality of outer ring hole columns are in spatial communication with the plurality of outer ring holes, respectively;
wherein an upper base line is defined in the cup body, and the upper base line is a horizontal line; wherein the space in the cup body above the upper base line is defined as an upper volume, and the space in the cup body below the upper base line is defined as a lower volume; wherein the plurality of outer ring hole columns are located in the lower volume, a lower base line is defined at upper ends of the plurality of outer ring hole columns, the lower base line is a horizontal line, and the lower base line is below the upper base line; wherein, after an amount of hot water is filled in the pour-over coffee dripper, the hot water is able to flow out from the at least one center hole and the plurality of outer ring holes, respectively; wherein, when a water level in the pour-over coffee dripper is lowered to be lower than a height of the upper ends of the plurality of outer ring hole columns, the hot water stops flowing out from the plurality of outer ring holes, and all of the remaining hot water flows out from the at least one center hole.
